(19) United States
(12) Patent Application Publication
(10) Pub. No.: US 2003/0000105 A1
(43) Pub. Date: Jan. 2, 2003

(54) Drum for clothes drier

(76) Inventors: Sung Bae Song, Seoul (KR); Sang Wook Hong, Seoul (KR); Sang Heon Yoon, Seoul (KR); Hwan Joo Myung, Seoul (KR)

Correspondence Address: BIRCH STEWART KOLASCH & BIRCH, PO BOX 747, FALLS CHURCH, VA, 22040-0747, US

(21) Appl. No.: 10/042,227

(22) Filed: Jan. 11, 2002

(30) Foreign Application Priority Data
Dec. 4, 2001 (KR) 76302/2001
Jun. 29, 2001 (KR) 38258/2001

(51) Int. Cl. F26B 11/02

(52) U.S. Cl. 34/595

(57) ABSTRACT

In a drum for a clothes drier having a plurality of baffles projected from the inner circumference of the drum, lifting and moving clothes, a drum for a clothes drier comprises a cylindrical body housing clothes and rotating and a plurality of baffles projected from the inner circumference of the cylindrical body in a length direction of the cylindrical body and lifting the clothes, wherein at least one baffle is installed at each disposal domain and is formed so as to be inclined with respect to the length direction of the cylindrical body when the inner circumference of the cylindrical body is divided into a plurality of disposal domains in the length direction of the cylindrical body. Accordingly, because the clothes housed in the drum can be regularly dispersed, contact of the clothes and heating air can be performed well, accordingly clothes drying efficiency can be improved.

### BACKGROUND OF THE INVENTION

1. Field of the Invention

The present invention relates to a drum for a clothes drier, and in particular to a drum for a clothes drier having a plurality of baffles projected from the internal circumference of a drum, lifting and moving clothes to be dried.

2. Description of the Background Art

Generally, a clothes drier dries laundry by removing water from the laundry. Usually the clothes drier is installed beside a washer, and a user dries laundry finishing all washing processes, namely, dehydrated clothes with the clothes drier.

FIG. 1 is a sectional view illustrating the conventional clothes drier. The conventional clothes drier includes a casing 10 formed as a hexahedral shape so as to have an internal space, a drum 30 rotatively placed inside the casing 10, a driving motor 20 installed inside the casing 10 and generating a driving force in order to rotate the drum 30, a belt 40 and a pulley 41 connecting the driving motor 20 with the drum 30 and transmitting the rotational force of the driving motor 20 to the drum 30, a rear plate 50 formed as a circular plate, covering the rear side of the drum 30 and having an air suction ports 51 constructed with a plurality of through holes, and a front plate 60 formed as a circular plate, covering the front side of the drum 30 and having an input opening 61 and an air exhaust port 62.

In addition, the clothes drier further includes a suction duct 70 connected to the air suction port 51 as a path at which air is sucked from outside into the drum 30, a heater (H) installed to an inlet portion of the suction duct 70 and heating the sucked air, an exhaust duct 80 connected to the air exhaust port 62 of the front plate 60 as a path at which air finishing the drying process inside the drum 30 is discharged, and a fan 91 installed inside the exhaust port 80 and generating blasts by the driving motor 20.

A door (D) opening/closing the clothes drier is installed to the front surface of the casing 10, and a filter (F) filtering impurities such as a nap, etc. is installed inside the exhaust duct 80.

In FIG. 1, unexplained reference numeral R is a roller supporting the drum 30, reference numeral 11 is a plurality of air holes formed at the casing 10.

The operation of the conventional clothes drier will be described.

First, a user opens the door (D) installed to the front surface of the casing 10, put clothes into the drum 30 through the input opening 61 and closes the door (D). And, when the user turns on an operation switch, power is applied to the driving motor 20, and the driving motor 20 is operated.

The driving force generated by the driving motor 20 is transmitted to the drum 30 through the pulley 40 and the belt 41, the drum 30 is rotated, and at the same time the fan 91 connected to the driving motor 20 is operated.

According to the rotation of the drum 30, the clothes put into the drum 30 drop rotaively, and at the same time air sucked from outside by the suction force of the fan 91 is heated by the heater (H) and flows into the drum 30 through the suction port 51 of the rear plate 50.

The heating air sucked into the drum 30 through the suction port 51 of the rear plate 50 dries the clothes rotativley dropping inside the drum 30, is exhausted through the exhaust port 62 of the front plate 60, and the air including moisture exhausted through the exhaust port 62 is discharged outside of the casing 10 through the exhaust duct 80.

By performing the process continually, the clothes put into the drum 30 are dried, when the drying process is finished, the user opens the door (D) and pulls out the dried clothes through the input opening 61.

In the meantime, a plurality of baffles 32 rotating together with the drum 30 are installed to the inner circumference of the drum 30 in order to increase a quantity of contact area with heating air.

In more detail, as depicted in FIG. 2 as a sectional view taken along the line A-A of FIG. 1 and FIG. 3 as a development view of the drum, the drum 30 of the clothes drier is constructed with a cylindrical body 31 and the plurality of baffles 32 projected from the inner circumference of the cylindrical body 31 at regular intervals toward the center of the rotation.

In the general clothes drier, the plurality of baffles 32 are lengthily formed along the length direction of the cylindrical body 31, herein three bafflers project from the inner circumference of the cylindrical body 31 at an angle of 120° in a normal direction of the cylindrical body 31.

When the cylindrical body 31 is rotated, the clothes drier including the plurality of baffles 32 moves and lifts the clothes inside the drum 30 to the upper portion of the drum 30, when the baffles 32 which the clothes are hanging on are moved to the upper portion of the drum 30, the clothes drop freely from the upper portion to the bottom portion of the drum 30, and the clothes are dried by contacting to heating air sucked through the suction port 51 of the rear plate 50 while dropping.

However, in the conventional clothes drier, because a length of the plurality of baffles 32 are same with a length of the cylindrical body 31, it is difficult to disperse the clothes regularly, accordingly the clothes are gathered around one place or are messed.

When the clothes are gathered around one place of the drum 30 or are messed, drying of the clothes may not be performed well, lots of time is required for drying the clothes, accordingly a clothes drying efficiency is sharply lowered.

Particularly, the clothes may be gathered around the exhaust port 62 of the front plate 60 by flow of heating air. In more detail, when the drum 30 is rotated, as depicted in FIG. 4, heating air sucked into the drum 30 through the suction port 51 flows into the upper portion of the drum 30 and is exhausted through the exhaust port 62, herein the clothes lifted up to the upper portion of the drum 30 by the baffles 32 drop freely and are gathered around the exhaust port 62 by the flow of the air.

As described above, when the clothes are gathered around the exhaust port 62, because it increases a flow friction of the air exhausted through the exhaust port 62, a load and a noise of the fan 91 are increased, in addition because a drying efficiency is lowered due to the decrease of air flow rate, a time required for drying the clothes is increased.

### SUMMARY OF THE INVENTION

In order to solve above-mentioned problems, it is an object of the present invention to provide a drum for a clothes drier which is capable of improving a clothes drying efficiency by facilitating contact of clothes and heating air by forming a plurality of baffles regularly dispersing clothes housed inside a drum.

In order to achieve the above-mentioned object, a drum for a clothes drier in accordance with the present invention includes a cylindrical body housing clothes and rotating, and a plurality of baffles projected from the inner circumference of the cylindrical body in a length direction of the cylindrical body and lifting the clothes, wherein the plurality of baffles are formed so as to have a different distance each other from the side of the cylindrical body.

The plurality of baffles are formed so as to become more distant from or get near to the side of the cylindrical body gradually at regular intervals.

In order to achieve the above-mentioned object, a drum for a clothes drier in accordance with the present invention includes a cylindrical body housing clothes and rotating, and a plurality of baffles projected from the inner circumference of the cylindrical body in a length direction of the cylindrical body and lifting the clothes, wherein at least one baffle is installed to each disposal domain when the inner circumference of the cylindrical body is divided into a plurality of disposal domains in a length direction of the cylindrical body.

The plurality of baffles are formed so as to have the same interval in the circumferential direction of the cylindrical body.

Each baffle has the same size as a width of each disposal domain at which each baffle is installed.

The plurality of disposal domains are set so as to have the same width each other in a length direction of the cylindrical body.

A ratio (h/d) of a height (h) of each baffle to the inner diameter (d) of the cylindrical body is within the range of 1/10˜2/10.

A ratio (I/L) of a length (I) of each baffle to a length (L) of the cylindrical body is greater than 3/10 and less than 10/10.

In the drum for the clothes drier in accordance with an embodiment of the present invention, the plurality of disposal domains are set so as to have a region overlapped each other.

In the drum for the clothes drier in accordance with another embodiment of the present invention, the disposal domains are set not to be overlapped each other.

In addition, in order to achieve the above-mentioned object, a drum for a clothes drier in accordance with the present invention includes a cylindrical body housing clothes and rotating, a plurality of baffles projected from the inner circumference of the cylindrical body in a length direction of the cylindrical body and lifting the clothes, wherein the plurality of baffles are formed so as to be inclined with respect to the length direction of the cylindrical body.

The cylindrical body sucks air through the side surface and discharge air through the other side surface, and the baffles placed at the side surface at which air is sucked are formed so as to be lower than the baffles placed at the other side surface at which air is discharged.

An angle of inclination (α) of the plurality of baffles is 0°<α≦20° in the length direction of the cylindrical body.

The plurality of baffles are formed so as to be inclined with respect to a normal direction of the cylindrical body.

An angle of inclination (β) of the plurality of baffles is 0°<β≦45° toward the normal direction of the cylindrical body.

A ratio (h/d) of a height (h) of each baffle to the inner diameter (d) of the cylindrical body is within the range of 1/10˜2/10.

One of the baffles has a protrusion portion projected from the end of the side at which air is discharged and having a certain height.

In addition, in order to achieve the above-mentioned object, a drum for a clothes drier in accordance with the present invention includes a cylindrical body housing clothes and rotating, a plurality of baffles projectied from the inner circumference of the cylindrical body in a length direction of the cylindrical body, wherein the cylindrical body sucks air through the side surface and discharges air through the other side surface, and one of the baffles has a protrusion portion projected from the end of the side at which air is discharged and having a certain height.

In addition, in order to achieve the above-mentioned object, a drum for a clothes drier in accordance with the present invention includes a cylindrical body housing clothes and rotating, a plurality of baffles projectied from the inner circumference of the cylindrical body in a length direction of the cylindrical body, wherein the plurality of baffles are formed so as to be inclined with respect to a normal direction of the cylindrical body.

The plurality of baffles are inclined with respect to the rotational direction.

In addition, in order to achieve the above-mentioned object, a drum for a clothes drier in accordance with the present invention includes a cylindrical body housing clothes and rotating, a plurality of baffles projected from the inner circumference of the cylindrical body in a length direction of the cylindrical body and lifting the clothes, wherein at least one baffle is installed at each disposal domain and is formed so as to be inclined with respect to the length direction of the cylindrical body when the inner circumference of the cylindrical body is divided into a plurality of disposal domains in the length direction of the cylindrical body.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal sectional view illustrating the conventional clothes drier;

FIG. 2 is a sectional view illustrating the conventional drum taken along the line A-A of FIG. 1;

FIG. 3 is a development view illustrating the drum of the conventional clothes drier;

FIG. 4 is a longitudinal sectional view illustrating an air flow state in the conventional clothes drier;

FIG. 5 is a longitudinal sectional view illustrating a clothes drier in accordance with a first embodiment of the present invention;

FIG. 6 is a sectional view illustrating the drum taken along the line B-B of FIG. 5;

FIG. 7 is a development view illustrating the drum of the clothes drier in accordance with the first embodiment of the present invention;

FIG. 8 is a development view illustrating a drum structure as a variation of the drum for the clothes drier in accordance with the first embodiment of the present invention;

FIG. 9 is a development view illustrating a drum structure for a clothes drier in accordance with a second embodiment of the present invention;

FIG. 10 is a development view illustrating a drum structure for a clothes drier in accordance with a third embodiment of the present invention;

FIG. 11 is a development view illustrating a drum structure for a clothes drier in accordance with a fourth embodiment of the present invention;

FIG. 12 is a longitudinal sectional view illustrating a drum structure for a clothes drier in accordance with a fifth embodiment of the present invention;

FIG. 13 is a sectional view illustrating the drum taken along the line C-C of FIG. 12;

FIG. 14 is a side view illustrating an angle of inclination of a baffle of the drum in accordance with the fifth embodiment of the present invention;

FIG. 15 is a development view illustrating the drum for the cloth drier in accordance with the fifth embodiment of the present invention;

FIG. 16 is a detail drawing illustrating a protrusion portion formed at the baffle of the drum in accordance with the fifth embodiment of the present invention;

FIG. 17 is a longitudinal sectional view illustrating a drum for a cloth drier in accordance with a sixth embodiment of the present invention;

FIG. 18 is a development view illustrating the drum for the cloth drier in accordance with the sixth embodiment of the present invention;

FIG. 19 is a development view illustrating a drum for a cloth drier in accordance with a seventh embodiment of the present invention;

FIG. 20 is a development view illustrating a drum for a cloth drier in accordance with an eighth embodiment of the present invention; and

FIG. 21 is a development view illustrating a drum for a cloth drier in accordance with a ninth embodiment of the present invention;

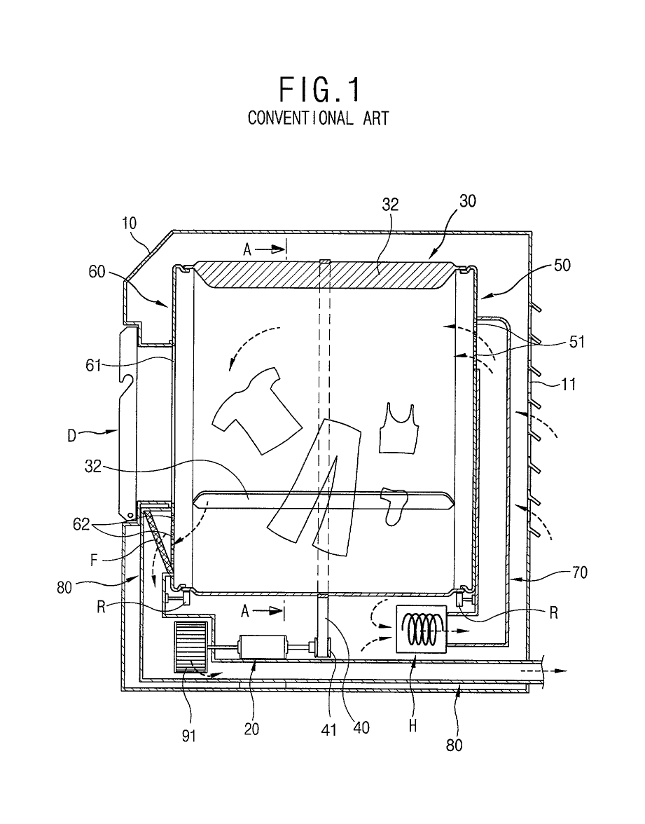

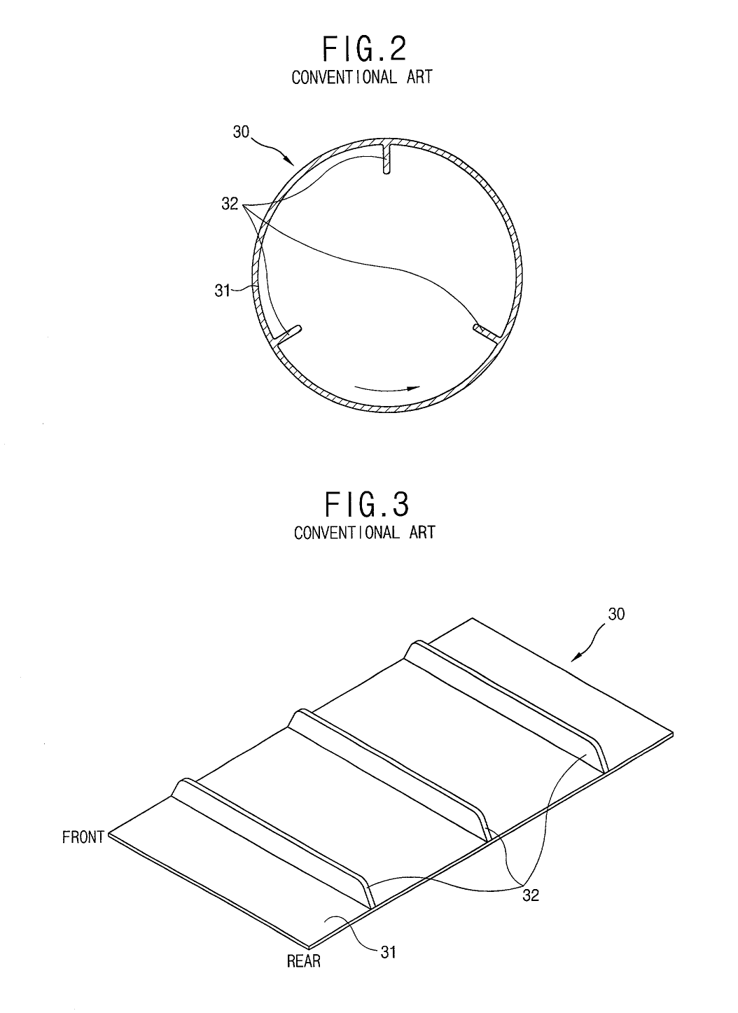

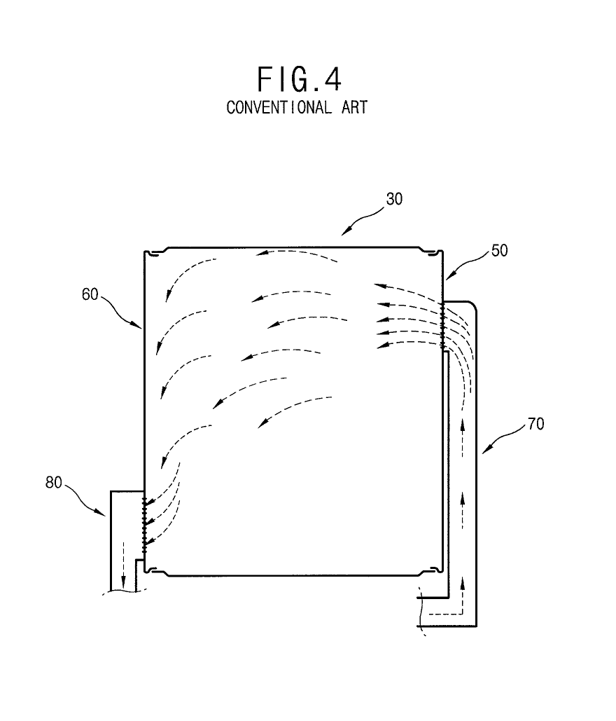

### DETAILED DESCRIPTION OF THE PREFERRED EMBODIMENTS

Hereinafter, embodiments of a drum for a cloth drier in accordance with the present invention will be described in detail with reference to accompanying drawings.

The same reference numerals will be given to the same parts as the conventional art.

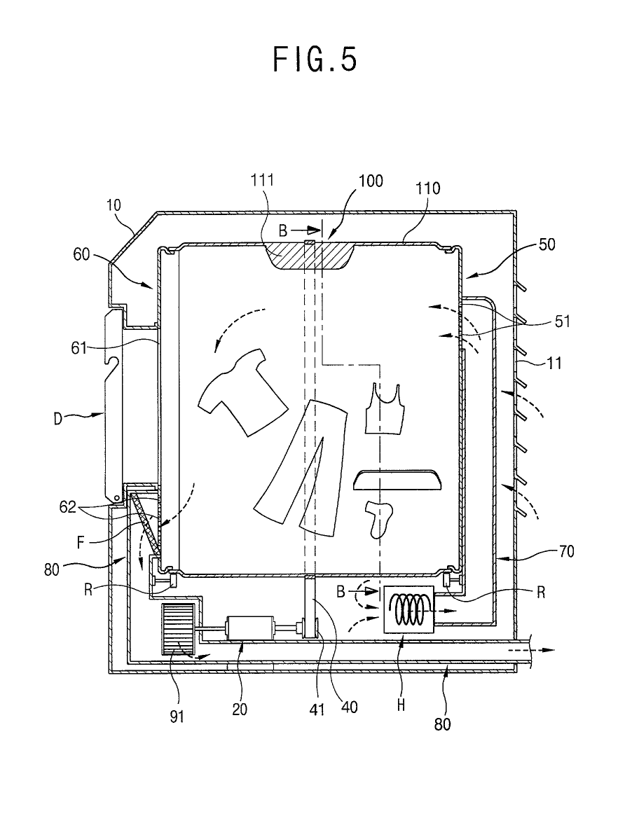

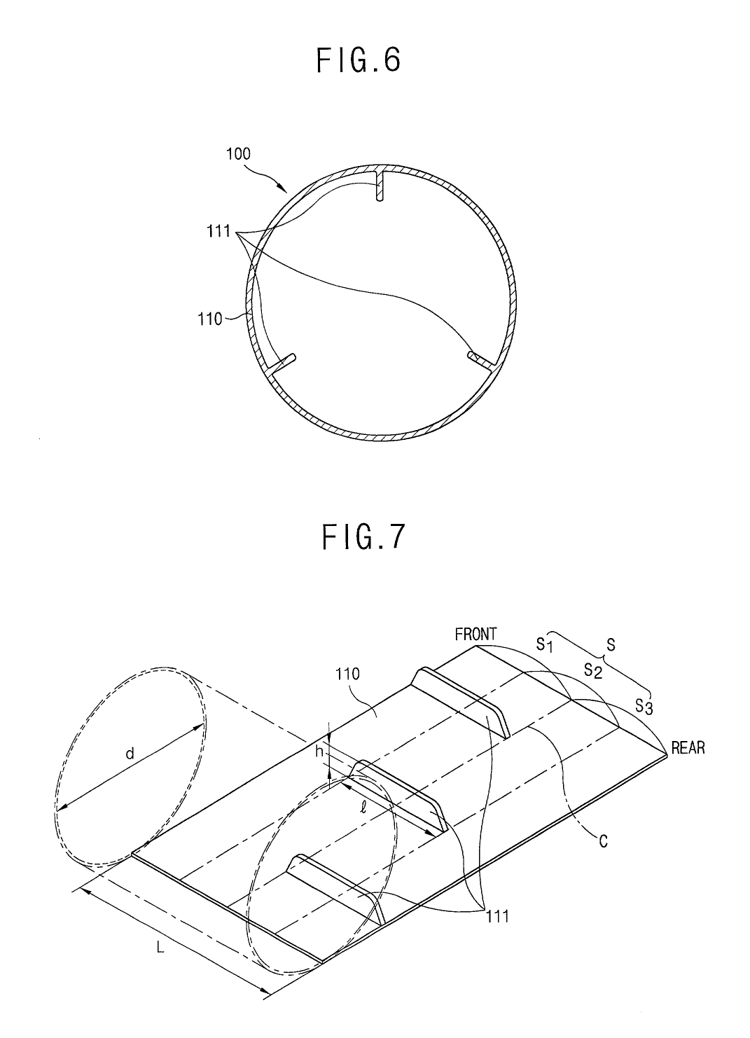

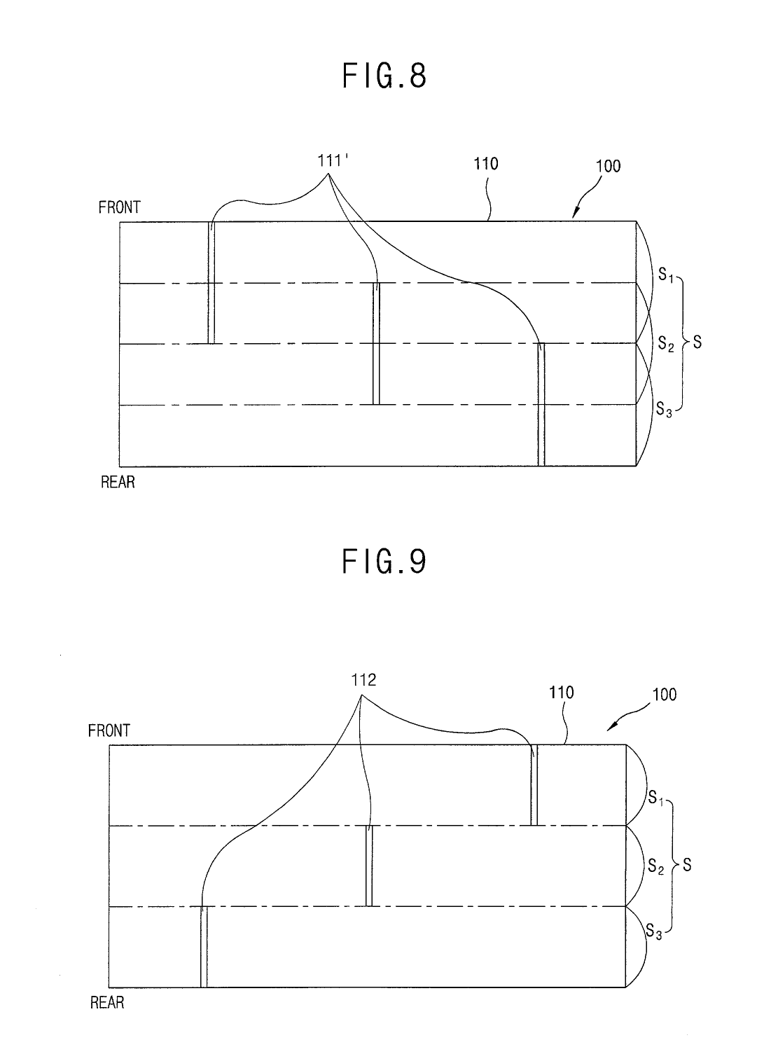

FIGS. 5˜8 illustrate a clothes drier in accordance with a first embodiment of the present invention, FIG. 5 is a longitudinal sectional view illustrating a clothes drier in accordance with a first embodiment of the present invention, FIG. 6 is a sectional view of the drum taken along the line B-B of FIG. 5, FIG. 7 is a development view illustrating the drum of the clothes drier in accordance with the first embodiment of the present invention, and FIG. 8 is a development view illustrating a drum structure as a variation of the drum for the clothes drier in accordance with the first embodiment of the present invention.

As depicted in FIG. 5, in the clothes drier in accordance with the first embodiment of the present invention, a cylindrical drum 100 is rotatively supported by a plurality of rollers inside a casing 10, and a driving motor 20 is installed to the internal lower portion of the casing 10. The driving motor 20 and the drum 100 are connected by a pulley 40 and a belt 41, and the driving force of the driving motor 20 is transmitted to the drum 100.

A circular plate shaped rear plate 50 is combined with the drum 100 so as to cover the rear portion of the drum 100, and a suction port 51 constructed with a plurality of holes is formed at the upper portion of the rear plate 50.

A suction duct 70 is connected to the suction port 51 of the rear plate 50 in order to suck outside air into the drum 100, and a heater (H) heating the sucked air is installed to an inlet portion of the suction duct 70.

A front plate 60 having a circular plate shape is installed to the front portion of the drum 100 so as to be perfomable a relative motion in order to cover the front portion of the drum 100. An input opening 61 at which a user puts/pulls clothes into/from the drum 100 and an exhaust port 62 constructed with a plurality of holes and exhausting air inside the drum 100 are formed at the front plate 60.

An exhaust duct 80 extended to the outside of the casing 10 is connected to the exhaust port 62 of the front plate 60, and a fan 91 is installed inside the exhaust duct 80 in order to generate air flow by receiving the driving force from the driving motor 20.

In the above-described clothes drier, as depicted in FIGS. 6 and 7, the drum 100 includes a cylindrical body 110 housing clothes and a plurality of baffles 111 projected from disposal domains demarcated on the inner circumference of the cylindrical body 110 so as to have a certain height.

In more detail, the plurality of baffles 111 are placed so as to become more distant from the side of the cylindrical body 110 one after another at regular intervals.

Herein, the inner circumference of the cylindrical body 110 is divided into three disposal domains (S1) (S2) (S3) having the same width, and the three disposal domains (S1) (S2) (S3) are overlapped each other as a certain width.

In more detail, on the basis of a center line (C) at right angles to the length direction of the cylindrical body 110, the disposal domain (S) is demarcated into two disposal domains (S1) (S3), on the basis of the center line (C), one disposal domain (S2) is demarcated so as to be overlapped with the two disposal domains (S1) (S3).

The disposal domains (S1) (S2) (S3) are demarcated so as to have a specific width in the length direction of the cylindrical body 110, each of the demarcated disposal domains (S1) (S2) (S3) has a cylindrical shape having a specific width.

And, one of the baffles 111 is installed to each of the disposal domains (S1) (S2) (S3), one of the baffles 111 is installed so as to have a length same with the width of each disposal domain (S1) (S2) (S3). In addition, each baffle 111 is placed so as to have a specific distance each other in the circumferential direction of the cylindrical body 110.

As depicted in FIG. 7, each of the three baffles 111 is installed in the order of the disposal domains (S1) (S2) (S3) in the rotational direction of the drum 100.

On the contrary, as depicted in FIG. 8, each of the three baffles 111 can be installed in the order of the disposal domains (S3) (S2) (S1) in the rotational direction of the drum 100.

In comparison with the inner diameter (d) of the cylindrical body 110, a ratio (h/d) of the height (h) of each baffle 111 to the inner diameter (d) of the cylindrical body 110 is within the range of 1/10˜2/10.

In addition, in comparison with a length (L) of the cylindrical body 110, a ratio (I/L) of a length (I) of each baffle 111 to a length (L) of the cylindrical body 110 is greater than 3/10 and less than 10/10.

In FIG. 5, unexplained reference numeral F is a filter, and reference numeral 11 is an suction hole at which air is sucked from outside.

The operation and the effects of the clothes drier in accordance with the first embodiment of the present invention will be described in more detail.

A user opens the door (D), puts clothes into the drum 100 through the input opening 61 and closes the door (D). And, when the user turns on an operation switch, power is applied to the driving motor 20, and the driving motor 20 is operated. When the driving motor 20 is operated, the driving force of the driving motor 20 is transmitted to the drum 100 through the belt 40 and the pulley 41, the drum 100 is rotated, and at the same time the fan 91 connected to the driving motor 20 is operated

According to the rotation of the drum 100, the clothes put into the drum 100 rotatively drop, and at the same time air sucked through the suction duct 70 by the suction force of the fan 91 is heated by the heater (H), the heating air flows into the drum 100 through the suction port 51 of the rear plate 50.

The heating air sucked into the drum 100 through the suction port 51 of the rear plate 50 dries the clothes rotatively dropping inside the drum 100, is exhausted to the exhaust port 62 of the front plate 60, the exhausted air including moisture is discharged to the outside of the casing 10 through the exhaust duct 80.

Particularly, the clothes housed inside the drum 100 move to the upper portion of the drum 100 by the plurality of baffles 111 respectively formed at the plurality of disposal domains (S) of the cylindrical body 110 of the drum 100 and drop, and the process is repeated.

Herein, because each baffle 111 of the drum 100 projects from each disposal domain, the clothes can be regularly dispersed and moved inside the drum 100, the clothes can be regularly contacted with the heating air, accordingly a clothes drying efficiency can be improved. In addition, it is possible to prevent the clothes from gathering around the exhaust port 62, accordingly the clothes can be easily contacted with the heating air and the flow resistance of the air can be minimized.

In more detail, because the plurality of baffles 111 are formed in the circumferential direction as a plurality of platforms, it is possible to prevent the clothes from gathering around the exhaust port 62 and disperse regularly the clothes inside the drum 100. Accordingly, the clothes can be easily contacted with the heating air, the flow resistance of the air can be minimized, a clothes drying time can be shortened, and a clothes drying efficiency can be improved.

By performing the above-described process continually, the clothes put into the drum 100 can be dried, when the drying operation is finished, the user opens the door (D) and pulls out the clothes through the input opening 61.

FIG. 9 is a development view illustrating a drum structure for a clothes drier in accordance with a second embodiment of the present invention.

As depicted in FIG. 9, in the drum 100 in accordance with the second embodiment of the present invention, unlike the first embodiment of the present invention, disposal domain at which each baffle is installed is demarcated so as not to be overlapped each other.

In more detail, three disposal domains (S1) (S2) (S3) which are not overlapped each other in the length direction of the cylindrical body 110 are demarcated on the inner circumference of the cylindrical body 110, one of baffles 112 having a specific height is installed to each disposal domain (S1) (S2) (S3).

And, each baffle 112 is placed at each disposal domain (S1) (S2) (S3) so as to have a specific distance each other in the circumferential direction of the cylindrical body 110.

Herein, as depicted in FIG. 9, each of the three baffles 112 is installed in the order of the disposal domains (S1) (S2) (S3) from the front plate 60 to the rear plate 50 in the rotational direction of the drum 100. On the contrary, each of the three baffles 112 can be installed in the order of the disposal domains (S3) (S2) (S1) from the rear plate 50 to the front plate 60 in the rotational direction of the drum 100.

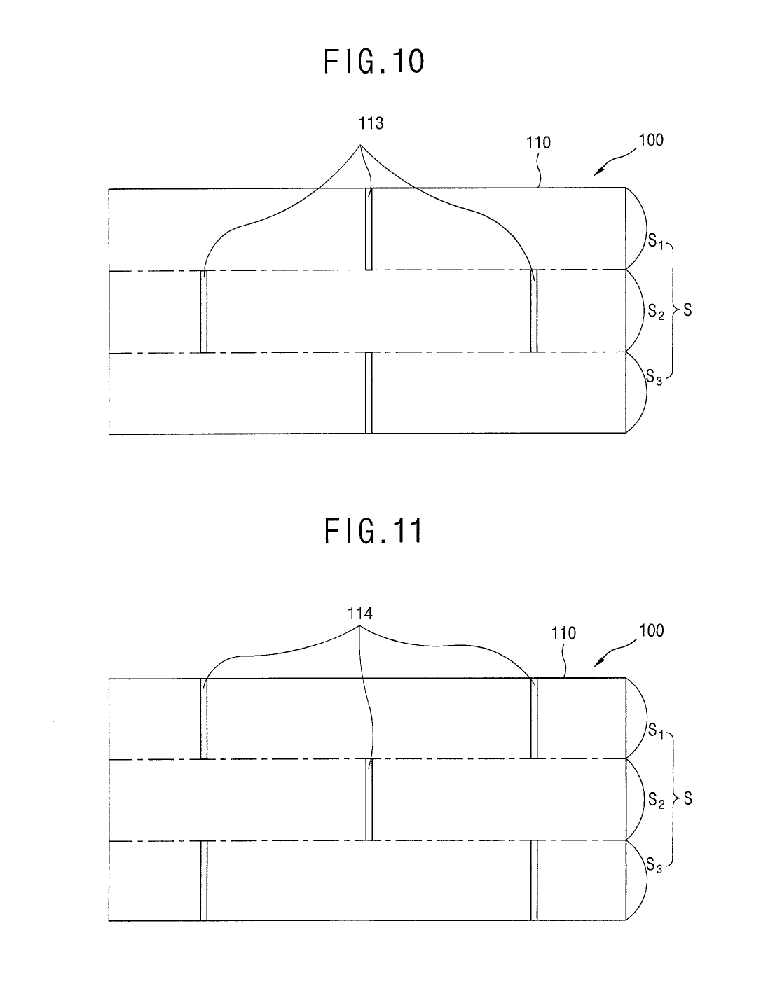

FIG. 10 is a development view illustrating a drum structure for a clothes drier in accordance with a third embodiment of the present invention.

As depicted in FIG. 10, in the drum 100 in accordance with the third embodiment of the present invention, three disposal domains are demarcated so as not to be overlapped each other, and each baffle 113 having a specific height is installed to each disposal domain (S1) (S2) (S3).

In the three disposal domains (S1) (S2) (S3), one baffle is respectively formed at both sides disposal domains (S1) (S3) so as to place at the same line each other in the length direction. Two baffles are formed at the center disposal domain (S2) so as to have a certain distance from each baffle 113 formed at the side disposal domains (S1) (S3) in the circumferential direction.

And, a total of four baffles are placed at regular intervals in the circumferential direction.

FIG. 11 is a development view illustrating a drum structure for a clothes drier in accordance with a fourth embodiment of the present invention.

In the drum 100 in accordance with the fourth embodiment of the present invention, on the contrary to the baffle arrange structure in accordance with the third embodiment of the present invention, in three disposal domains (S1) (S2) (S3), two baffles 114 are respectively formed at both sides disposal domains (S1) (S3) so as to place at the same line each other in the length direction. One baffle is formed at the center disposal domain (S2).

A total of five baffles 114 are placed at regular intervals in the circumferential direction of the cylindrical body 110.

In the clothes drier in accordance with the second, the third and the fourth embodiments of the present invention, because the plurality of baffles are formed in the circumferential direction as a plurality of platforms, it is possible to prevent the clothes from gathering around the exhaust port 62 and disperse the clothes regularly inside the drum 100. Accordingly, the clothes can be easily contacted with the heating air, the flow resistance of the air can be minimized, a clothes drying time can be shortened, and a clothes drying efficiency can be improved.

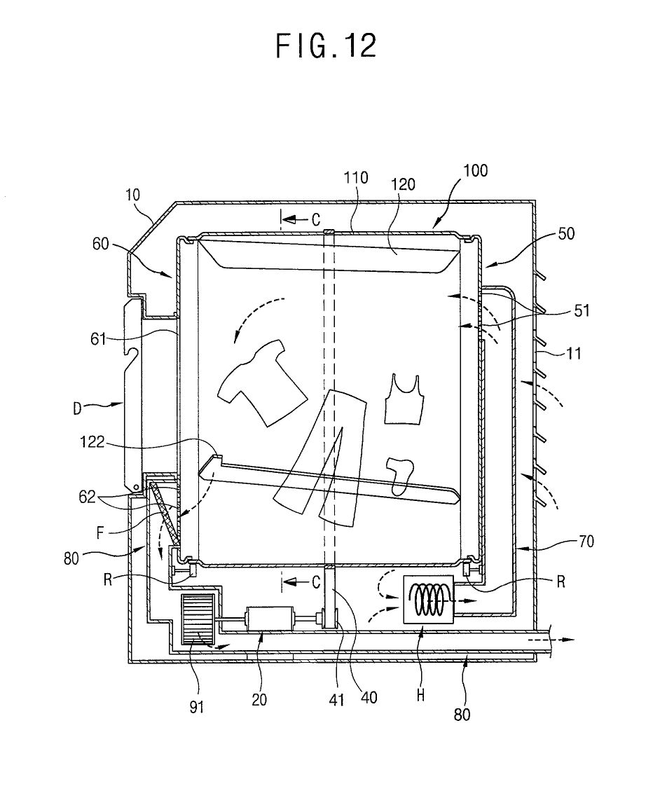

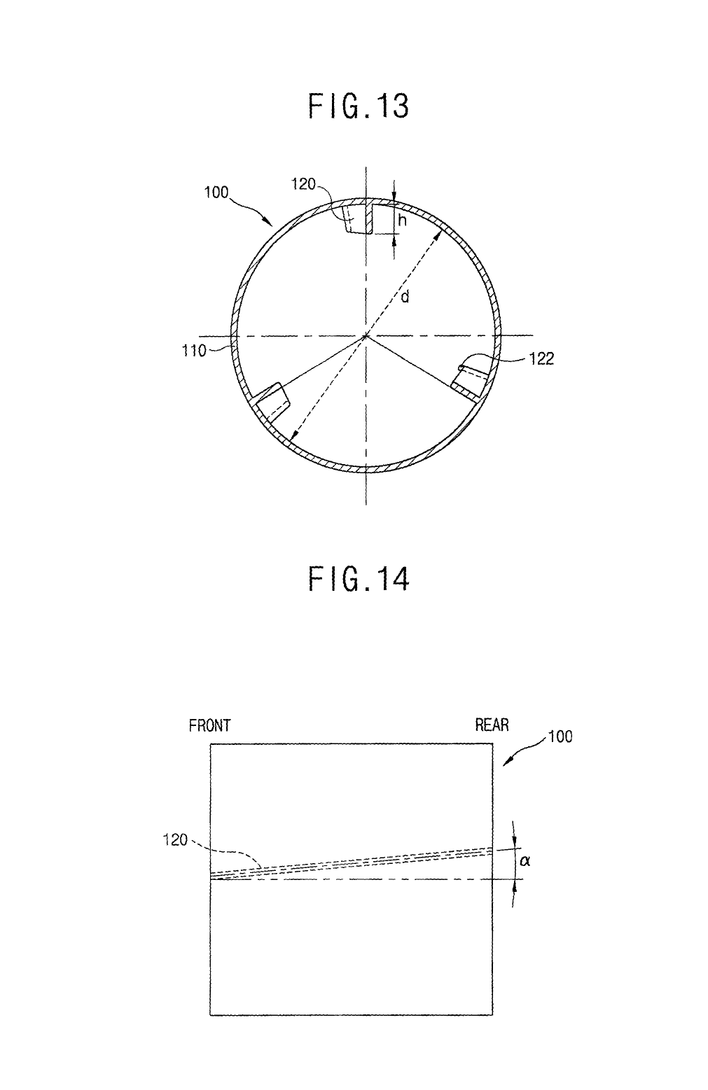

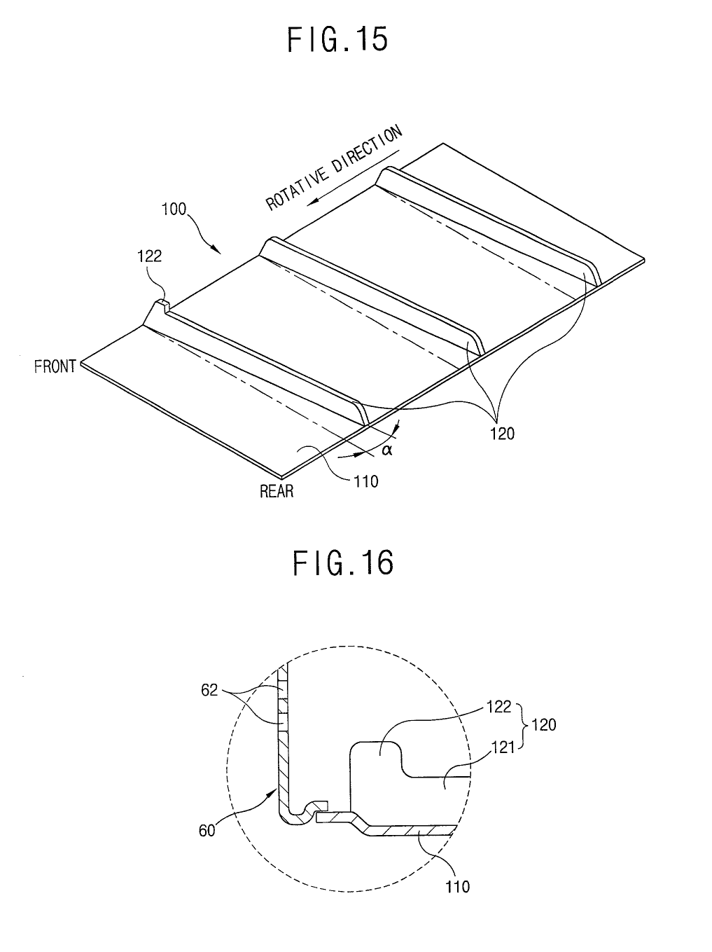

FIGS. 12˜16 illustrate a clothes drier in accordance with a fifth embodiment of the present invention, herein FIG. 12 is a longitudinal sectional view illustrating a drum structure for a clothes drier in accordance with a fifth embodiment of the present invention, FIG. 13 is a sectional view illustrating the drum taken along the line C-C of FIG. 12, FIG. 14 is a side view illustrating an angle of inclination of a baffle of the drum in accordance with the fifth embodiment of the present invention, FIG. 15 is a development view illustrating the drum for the cloth drier in accordance with the fifth embodiment of the present invention, and FIG. 16 is a detail drawing illustrating a protrusion portion formed at the baffle of the drum in accordance with the fifth embodiment of the present invention;

As depicted in FIG. 12, the clothes drier in accordance with the fifth embodiment of the present invention includes the casing 10, the drum 100 rotatively installed inside the casing 10, and the driving motor 20 installed inside the casing 10 and rotating the drum 100.

The rear plate 50 is installed to the rear of the drum 100, and the front plate is installed to the front of the drum 100. The suction duct 70 is connected to the suction port 51 of the rear plate 50, and the heater (H) is installed to an inlet portion of the suction port 70.

The inlet opening 61 and the exhaust port 62 are formed at the front plate 60, and the exhaust duct 80 is connected to the exhaust port 62. The fan 91 rotated by the driving motor 20 is installed inside the exhaust duct 80.

Particularly, the drum 100 includes the cylindrical body 110 housing clothes and the plurality of baffles 120 projected from the inner circumference of the cylindrical body 110 and moving the clothes when the cylindrical body 110 is rotated.

The baffles 120 are lengthily formed so as to be similar to the length of the cylindrical body 110 and are placed at regular intervals in the circumferential direction of the cylindrical body 110. Particularly, the baffles 120 are formed so as to be inclined at a certain angle toward the length direction of the drum 100.

As depicted in FIG. 14, it is preferable to set an angle of inclination (α) of the plurality of baffles 120 as 0°<α≦20°.

In the plurality of baffles 120, on the basis of the baffle lifting the clothes in the rotational direction of the drum 100, a height of the baffle abutting on the rear plate 50 is lower than a height of the baffle abutting on the front plate 60.

A ratio (h/d) of the height (h) of each baffle 120 to the inner diameter (d) of the cylindrical body 110 is within the range of 1/10˜2/10.

As depicted in FIG. 16, a protrusion portion 122 is formed at the end of a certain baffle of the baffles 120. In more detail, the baffle 120 having the protrusion portion 62 is constructed with a wing portion 121 projected from the inner circumference of the cylindrical body 110 and the protrusion portion 122 projected relatively high from the end of the wing portion 121.

In the clothes drier in accordance with the fifth embodiment of the present invention, by the baffles 120 projected so as to be inclined, the clothes can be regularly dispersed and moved inside the drum 100, and it is possible to prevent the clothes from gathering around the exhaust port 62.

In more detail, the heating air sucked into the drum 100 through the suction port 62 of the rear plate 50 flows inside the drum 100 and is exhausted through the exhaust port 62 of the front plate 60. At the same time, the clothes rotating together with the drum 100 by engaging with the baffles 120 are moved to the rear plate 50 at which the suction port 51 is formed in the inclination direction of the baffles 120.

Accordingly, the clothes can be contacted with the heating air many times, and it is possible to prevent the clothes from gathering around the front plate 60 at which the exhaust port 62 is formed, accordingly the clothes drying efficiency can be improved.

In the meantime, as depicted in FIG. 16, because the protrusion portion 122 formed at one or more than one of the plurality of baffles 120 has the larger engaging area with the clothes, the clothes can be more easily dispersed, accordingly it is possible to prevent the clothes from gathering around the exhaust port 62 more efficiently.

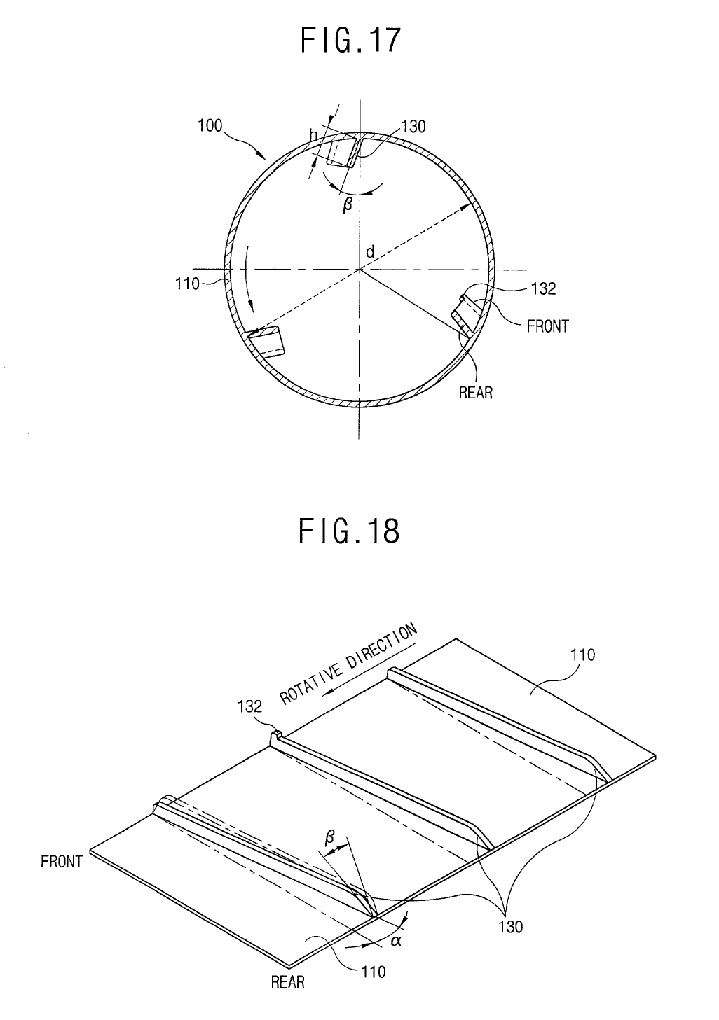

FIG. 17 is a longitudinal sectional view illustrating a drum for a cloth drier in accordance with a sixth embodiment of the present invention, and FIG. 18 is a development view illustrating the drum for the cloth drier in accordance with the sixth embodiment of the present invention.

The drum in accordance with the sixth embodiment of the present invention includes the cylindrical body 110 housing clothes and rotating, and a plurality of baffles 130 projected from the inner circumference of the cylindrical body 110 in a length direction of the cylindrical body and formed so as to be inclined with respect to a normal direction of the cylindrical body 110.

The plurality of baffles 130 are formed at regular intervals in the circumferential direction of the cylindrical body 110. And, an angle of inclination (α) of the plurality of baffles 130 is 0°<α≦20° toward the length direction of the cylindrical body 110, and an angle of inclination (β) of the plurality of baffles 130 is 0°<β≦45° toward the normal direction of the cylindrical body.

The height (h) of the baffles 130 is the same each other, and a ratio (h/d) of the height (h) of each baffle 130 to the inner diameter (d) of the cylindrical body is within the range of 1/10˜2/10.

And, a protrusion portion 132 having a certain height is formed at the end of a certain baffle of the baffles 130.

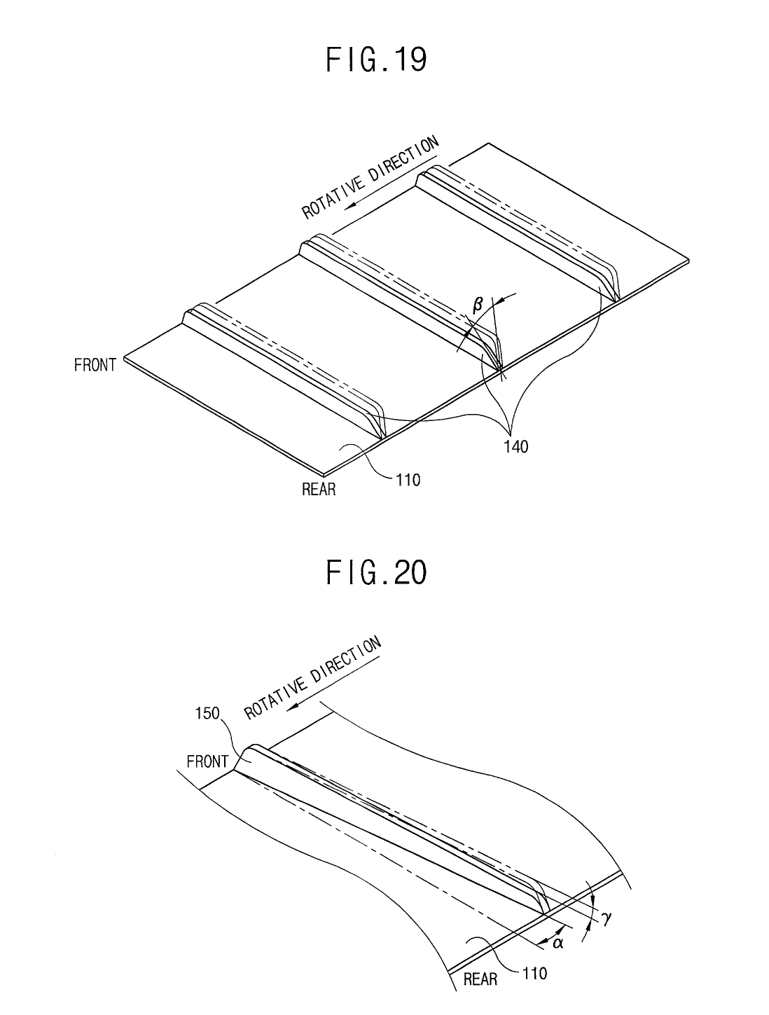

FIG. 19 is a development view illustrating a drum for a cloth drier in accordance with a seventh embodiment of the present invention.

As depicted in FIG. 19, in the drum in accordance with the seventh embodiment of the present invention, a plurality of baffles 140 are formed so as to have an angle of inclination (β) toward the normal direction of the cylindrical body 110 and are placed at regular intervals in the circumferential direction of the cylindrical body 110.

The baffles 140 are formed so as to be inclined with respect to the rotational direction.

In the clothes drier in accordance with the sixth and the seventh embodiments of the present invention, because a plurality of baffles are formed so as to be inclined with respect to the length direction and the normal direction of the drum 100, the clothes can be regularly dispersed and moved inside the drum 100, the flow resistance of the air can be minimized by preventing the clothes from gathering around the exhaust port 62, accordingly a load on the fan can be reduced and a noise can be minimized. In addition, by improving a clothes drying efficiency, a clothes drying time can be shortened and a power consumption can be minimized.

FIG. 20 is a development view illustrating a drum for a cloth drier in accordance with an eighth embodiment of the present invention; and

Same as the fifth embodiment, in the clothes drier in accordance with the eighth embodiment of the present invention, a plurality of baffles 150 are formed so as to have an angle of inclination (α) toward the length direction of the cylindrical body 110.

Particularly, each of the baffles 150 is formed so as to be inclined. In more detail, a height of the baffles 155 abutting on the front plate 60 is higher than a height of the baffles 150 abutting on the rear plate 50.

Herein, an angle of inclination (γ) of the plurality of baffles is 0°<γ≦10°.

In the clothes drier in accordance with the eighth embodiment of the present invention, by the baffles 150 formed so as to have a larger engaging area toward the exhaust port of the front plate 60, it is possible to prevent the clothes from gathering around the exhaust port 62.

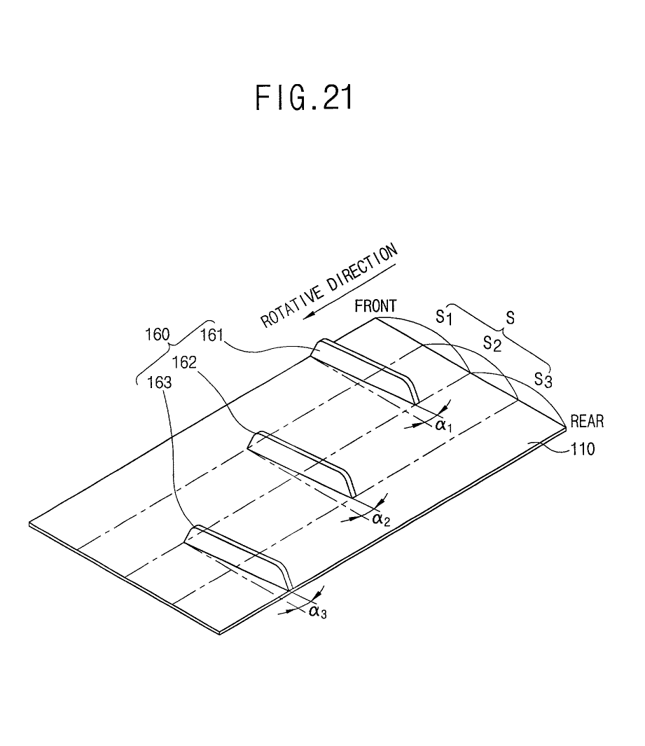

FIG. 21 is a development view illustrating a drum for a cloth drier in accordance with a ninth embodiment of the present invention.

The ninth embodiment of the present invention combines the construction of the first embodiment with the construction of the fifth embodiment.

As depicted in FIG. 21, in the clothes drier in accordance with the nenth embodiment of the present invention, each baffle 161, 162, 163 is installed to each disposal domain (S1) (S2) (S3) demarcated so as to have a regular length toward the length direction of the cylindrical body 110.

In addition, the baffles 161, 162, 163 are formed so as to be inclined with respect to the length direction of the cylindrical body 110. Herein, each baffle 161, 162, 163 has the same angle of inclination (α₁, α₂, α₃), and the baffles 161, 162, 163 can have a different angle of inclination according to design conditions.

In the meantime, in the clothes drier in accordance with the ninth embodiment of the present invention, each baffle 161, 162, 163 can be variously formed at each disposal domain same as the second˜the fourth embodiments, in addition, and each baffle 161, 162, 163 can be formed so as to have a various angle of inclination and height same as the sixth˜the eighth embodiments.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such metes and bounds are therefore intended to be embraced by the appended claims.

What is claimed is:

1. A drum for a clothes drier, comprising:
a cylindrical body housing clothes and rotating; and
a plurality of baffles projected from the inner circumference of the cylindrical body in a length direction of the cylindrical body and lifting the clothes;
wherein the plurality of baffles are formed so as to have a different distance each other from the side of the cylindrical body.

2. A drum for a clothes drier, comprising:
a cylindrical body housing clothes and rotating; and
a plurality of baffles projected from the inner circumference of the cylindrical body in a length direction of the cylindrical body and lifting the clothes;
wherein at least one baffle is installed to each disposal domain when the inner circumference of the cylindrical body is divided into a plurality of disposal domains in a length direction of the cylindrical body.

3. The drum for the clothes drier according to claim 2, wherein the plurality of disposal domains are set so as to have a region overlapped each other.

4. The drum for the clothes drier according to claim 2, wherein the disposal domains are set not to be overlapped each other.

5. The drum for the clothes drier according to claim 2, wherein a ratio (h/d) of a height (h) of each baffle to the inner diameter (d) of the cylindrical body is within the range of 1/10˜2/10.

6. The drum for the clothes drier according to claim 2, wherein a ratio (I/L) of a length (I) of each baffle to a length (L) of the cylindrical body is greater than 3/10 and less than 10/10.

7. A drum for a clothes drier, comprising:
a cylindrical body housing clothes and rotating;
a plurality of baffles projected from the inner circumference of the cylindrical body in a length direction of the cylindrical body and lifting the clothes;
wherein the plurality of baffles are formed so as to be inclined with respect to the length direction of the cylindrical body.

8. The drum for the clothes drier according to claim 7, wherein the cylindrical body sucks air through the side surface and discharge air through the other side surface, and the baffles placed at the side surface at which air is sucked are formed so as to be lower than the baffles placed at the other side surface at which air is discharged, in the position lifting the clothes.

9. The drum for the clothes drier according to claim 7, wherein an angle of inclination (α) of the plurality of baffles is 0°<α≦20° in the length direction of the cylindrical body.

10. The drum for the clothes drier according to claim 7, wherein the plurality of baffles are formed so as to be inclined with respect to a normal direction of the cylindrical body.

11. The drum for the clothes drier according to claim 10, wherein an angle of inclination (β) of the plurality of baffles is 0°<β≦45° toward the normal direction of the cylindrical body.

12. The drum for the clothes drier according to claim 7, wherein a ratio (h/d) of a height (h) of each baffle to the inner diameter (d) of the cylindrical body is within the range of 1/10˜2/10.

13. The drum for the clothes drier according to claim 7, wherein the plurality of baffles are formed so as to be inclined from the end portion abutting on the inner diameter of the cylindrical body to the other end portion.

14. The drum for the clothes drier according to claim 13, wherein the cylindrical body sucks air through the side surface and discharges air through the other side surface, and the baffles placed at the other side surface at which air is discharged are formed so as to be higher than the baffles placed at the side surface at which air is sucked.

15. The drum for the clothes drier according to claim 13, wherein an angle of inclination (γ) of the height variation of the plurality of baffles is 0°<γ≦10°.

16. The drum for the clothes drier according to claim 7, wherein the cylindrical body sucks air through the side surface and discharges air through the other side surface, and at least one of the baffles has a protrusion portion projected from the end of the side at which air is discharged and having a certain height.

17. A drum for a clothes drier, comprising:
a cylindrical body housing clothes and rotating;
a plurality of baffles projected from the inner circumference of the cylindrical body in a length direction of the cylindrical body;
wherein the cylindrical body sucks air through the side surface and discharges air through the other side surface, and at least one of the baffles has a protrusion portion projected from the end of the side at which air is discharged and having a certain height.

18. A drum for a clothes drier, comprising:
a cylindrical body housing clothes and rotating;
a plurality of baffles projected from the inner circumference of the cylindrical body in a length direction of the cylindrical body;
wherein the plurality of baffles are formed so as to be inclined with respect to a normal direction of the cylindrical body.

19. The drum for the clothes drier according to claim 18, wherein an angle of inclination (β) of the plurality of baffles is 0°<β≦45° toward the normal direction of the cylindrical body.

20. A drum for a clothes drier, comprising:
a cylindrical body housing clothes and rotating; and
a plurality of baffles projected from the inner circumference of the cylindrical body in a length direction of the cylindrical body and lifting the clothes;
wherein at least one baffle is installed at each disposal domain and is formed so as to be inclined with respect to the length direction of the cylindrical body when the inner circumference of the cylindrical body is divided into a plurality of disposal domains in the length direction of the cylindrical body.
